(19) United States
(12) Patent Application Publication
(10) Pub. No.: US 2010/0121704 A1
(43) Pub. Date: May 13, 2010

(54) Activating Content Distribution

(76) Inventors: Vincent Vanhoucke, San Francisco, CA (US); Michael H. Cohen, Portola Valley, CA (US); Manish G. Patel, Mountain View, CA (US); Gudmundur Hafsteinsson, Los Gatos, CA (US)

Correspondence Address: FISH & RICHARDSON P.C., PO BOX 1022, MINNEAPOLIS, MN, 55440-1022, US

(21) Appl. No.: 12/617,266

(22) Filed: Nov. 12, 2009

Related U.S. Application Data
(60) Provisional application No. 61/114,241, filed on Nov. 13, 2008.

(51) Int. Cl. G06Q 30/00

(52) U.S. Cl. 705/14.45; 705/14.53; 705/14.58

(57) ABSTRACT

A computer-implemented method for advertisement distribution includes receiving, in a computer system, an input from an advertiser that has previously registered an advertisement for on-demand activation. The input is generated based on the advertiser having an immediate availability and directs the computer system to initiate the on-demand activation substantially in real time with receiving the input. The method includes determining, using the computer system, a geographic location of the advertiser that corresponds to the immediate availability. The method includes defining, using the computer system, a target group to which the advertisement is to be presented, the target group identified based on at least the geographic location and the immediate availability. The method includes initiating the on-demand activation using the computer system, for receipt of the advertisement by at least part of the target group, the on-demand activation initiated substantially in real time with receiving the input.

### RELATED PATENT APPLICATION

This application claims priority from U.S. Provisional Application Ser. No. 61/114,241, filed Nov. 13, 2008 and entitled “Activating Content Distribution,” the contents of which are incorporated herein by reference.

### TECHNICAL FIELD

This document relates to information processing.

### BACKGROUND

Advertising can be presented in a variety of communication mediums such as periodicals, billboards, radio, and television, to name just a few of many examples. With the rise of the Internet, online mediums are increasingly being used for advertising in novel ways. Often times advertisers will target products and services to a particular demographic. A website devoted to a particular trade or hobby is a popular location for businesses specializing in that trade or hobby to advertise to potential customers and increase their sales. The increase in advertising has created an incentive for content distributors to aid in targeting advertisements to consumers.

### SUMMARY

The invention relates to activating content distribution.

In a first aspect, a computer-implemented method for advertisement distribution includes receiving, in a computer system, an input from an advertiser that has previously registered an advertisement for on-demand activation. The input is generated based on the advertiser having an immediate availability and directs the computer system to initiate the on-demand activation substantially in real time with receiving the input. The method includes determining, using the computer system, a geographic location of the advertiser that corresponds to the immediate availability. The method includes defining, using the computer system, a target group to which the advertisement is to be presented, the target group identified based on at least the geographic location and the immediate availability. The method includes initiating the on-demand activation using the computer system, for receipt of the advertisement by at least part of the target group, the on-demand activation initiated substantially in real time with receiving the input.

Implementations can include any or all of the following features. The on-demand activation can cause the advertisement to begin being subject to display in an electronic medium. The on-demand activation can include that the advertisement is to be displayed on a page in the electronic medium subject to a determination that the advertisement relates to the page. The on-demand activation can cause the advertisement to begin being subject to performance in a voice communication medium. The voice communication medium can be configured for prospective customers to seek information about a business type, and the on-demand activation can include that the advertisement is to be communicated in the voice communication medium to at least one of the prospective customers subject to a determination that the advertiser is associated with the business type.

The method can further include determining a business type of the advertiser before identifying the target group; wherein the target group is identified based also on the business type. The business type can be one where prospective customers of the business type have an essentially immediate need for a business of the business type. The business type can be one where the advertiser has intermittent periods of inactivity during which the advertiser has capacity to take on a new customer. The advertiser may previously have bid a first amount for presentation of the advertisement, and the input can correspond to the advertiser increasing the first amount to a second amount. The on-demand activation can define an end time where the on-demand activation is to terminate. The end time can be defined such that the on-demand activation is to be terminated upon receipt of a response from at least one member of the target group. The method can further include detecting the response from the member to the advertisement; and recording information about the response in association with at least one of the advertiser or the advertisement. The advertisement can be presented in a first medium and the response from the member can occur in a second medium other than the first medium. The method can further include forwarding a communication to the advertiser indicating that the response was received as a result of the on-demand activation.

In a second aspect, a computer-implemented method for advertisement distribution includes detecting, in a computer system, that a criterion is met for advertisement presentation on behalf of at least one advertiser. The advertiser has previously registered an advertisement as subject to on-demand activation. The method further includes prompting the advertiser, using the computer system and substantially in real time with the detection, to initiate the on-demand activation. The method further includes receiving an input from the advertiser in the computer system, the input directing the computer system to initiate the on-demand activation substantially in real time with receiving the input. The method further includes initiating the on-demand activation using the computer system, for receipt of the advertisement by at least part of a target group, the on-demand activation initiated substantially in real time with receiving the input.

Implementations can include any or all of the following features. The advertiser may previously have bid a first amount for presentation of the advertisement, and the input can correspond to the advertiser increasing the first amount to a second amount. The on-demand activation can define an end time where the on-demand activation is to terminate. The end time can be defined such that the on-demand activation is to be terminated upon receipt of a response from at least one member of the target group. The method can further include detecting the response from the member to the advertisement; and recording information about the response in association with at least one of the advertiser or the advertisement.

Implementations can provide any, all or none of the following advantages. An improved advertisement management system can be provided. Content such as advertisements can be published essentially in real time relative to when an advertiser becomes available. Content distributors such as advertisers can communicate with, and receive responses from, prospective customers essentially at the time when the content distributor is available.

The details of one or more embodiments are set forth in the accompanying drawings and the description below. Other features and advantages will be apparent from the description and drawings, and from the claims.

### DESCRIPTION OF DRAWINGS

FIG. 1A and FIG. 1B depict an example system that can provide just-in-time content distribution.

FIG. 2A and FIG. 2B depict an example system that can provide just-in-time content distribution over a voice medium.

FIGS. 3 and 4 are flowcharts depicting example procedures for just-in-time content distribution.

FIG. 5 is a block diagram of a computing system that can be used in connection with computer-implemented methods described in this document.

Like reference symbols in the various drawings indicate like elements.

### DETAILED DESCRIPTION

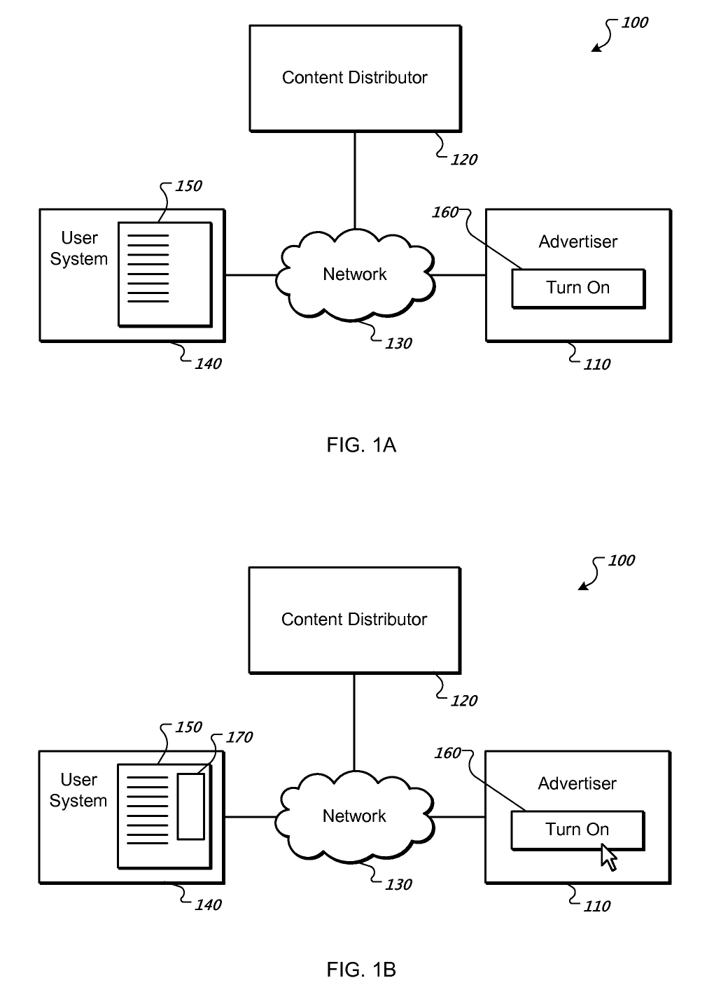

FIG. 1A and FIG. 1B depict an example system 100 that can provide just-in-time content distribution. An operator of an advertiser system 110 may wish to advertise a service or product to potential customers in a timely matter. For example, a plumber has an immediate opening in his or her schedule due to a cancellation and wishes to immediately connect with potential customers. The advertiser system 110 can communicate with a content distributor system 120 over any kind of network 130, such as the Internet. The content distributor system 120 provides a way to distribute advertisements and/or other content to end users over the same or a different network substantially simultaneously with activation by a content provider (e.g., an advertiser), as will be illustrated by examples below.

The content distributor 120 provides contents such as advertisements over the network 130 to at least one user system 140. The user system can include a web browser 150 capable of displaying advertisements along with other content. In an example targeted advertising system, a user searches for a keyword or keywords, the content distributor 120 provides advertisements that are relevant to those particular keywords, and the advertisement(s) appear on a page of search results. In this example, if a user was searching for an Italian restaurant in a particular city, the content distributor may provide advertisements for restaurants in that city, or other related advertisements such as an advertisement for Italian cookware. As another example, the browser can load a particular page which can be augmented with selected advertising targeted, for example, to the user and/or other contents of the page.

The advertiser can have an established business relationship with the content distributor 120. The content distributor 120 can track each view, click, phone call, or other metric to determine if a user has seen, heard or been presented the advertisement, and can bill the advertiser appropriately.

The content, such as advertisements, may not be continuously displayed, however. Rather, the advertiser may wish to activate an advertisement essentially in connection with times or periods when the advertiser is actively seeking customers. In some implementations, the customers interested in the type of products and/or service that the advertiser provides may generally have an immediate need for the service/product, and if the advertiser is unable to attend to the customer more or less at the time the need arises, the customer may continue searching for another vendor. Thus, the advertiser may have an interest in regulating the presentation of the content on the advertiser's behalf, such as an advertisement, such that it correlates with an availability of the advertiser. In the example system 100, the advertiser system 110 has a control 160 for turning on the advertisement substantially in real time (where turning on refers to the immediate availability of the advertisement for presentation to a user).

In FIG. 1B the operator of the advertiser system 110 activates the control 160 to turn on the advertisement. For example, activating the control 160 can include submitting a web form, clicking a button, making a phone call, or using some other form of communicating, to announce that the advertiser wishes to advertise immediately. Information indicating that the control has been activated is sent over the network to the content distributor 120. In response, the content distributor can provide an advertisement 170 in the web browser 150 of the user system 140. For example, after the content distributor system 120 receives the advertiser's announcement (e.g., advertisement 1 is ready to go live and the advertiser is ready to support interaction with the presented ad), the content distributor system 120 can begin inserting the advertisement 170 in content in one or more ways, such as by forwarding an online text advertisement for display on the user system 140.

The operator of the advertiser system 110 can provide additional content with the submission. In some implementations, a communication between the advertiser system 110 and the content distributor 120 can include information relevant to a user. For example, the communication can include details about the business, available appointment times, contact information and/or various types of multimedia or other documents.

As another example, the communication can include a presentation plan. For example, a presentation plan can include details about how the content such as an advertisement is to be presented including, but not limited to, the key words relevant to the advertisement, such as a business type or items offered for sale.

The communication can contain bidding information. For example, the operator of the advertiser system 110 running an advertisement through the content distributor 120 may wish to increase the amount they are willing to pay to have the advertisement presented to a user. The advertiser can be willing to pay a different amount for a particular type of connection. For example, the advertiser may be willing to pay more for a telephone call than a click through to a website. Information about the user response can be stored with the presentation plan, and can be sent to the advertiser system 110.

The content distributor 120 can use the aforementioned details to present the advertisement 170 to users with essentially an immediate need for the business or business type. The content distributor 120 can use the keywords or the geographical location of the business to determine which users to send the presentation to. For example, if a user of a mapping program searched for a business in a particular location, an advertisement could be selected for presentation to the user based on the geographical area the user is viewing or recently viewed.

When the advertisement 170 is provided to a user system 140, a user can view the advertisement. In some situations, the user chooses to take no further action. However, the user has the ability to interact with (e.g., click on) the advertisement 170, thus initiating some other action, such as booking an appointment or navigating to another website where the user can book an appointment, to name just two examples. The user can use some alternative method of contacting an advertiser, for example, by making a telephone call or visiting the advertiser's website. The content distributor 120 can track the various metrics relating to user communications with the advertiser, and can bill the advertiser for a conversion (e.g., a successful booking, a successful connection, a telephone call, a successful view of the advertisement) or some other metric. Once resources of the advertiser have been consumed, the advertisement can be disabled (e.g., no longer presented to users). For example, upon a user booking an appointment, the operator of the advertiser system 110 can turn off the advertisement or can leave it on for other appointment slots. For example, a restaurant with multiple tables available may wish to keep an advertisement running until the moment all the available tables or reservation slots are filled. The presentation plan can define an end time in which the advertisement is to terminate.

Examples have been described in which the operator of the advertiser system 110 turns on the advertisement. In some implementations, the content distributor 120 queries the advertiser system 110 in real time to determine if the advertiser wishes to advertise to a user. For example, if a user employs the user system 140 to search for restaurants in a particular area of town, the content distributor 120 may contact a restaurant substantially in real time to see if the restaurant wishes to turn on the advertisement 170. The content distributor 120 can contact multiple businesses to ask if they wish to turn on an advertisement. The content distributor 120 can initiate a bidding process as part of this communication. For example, the content distributor 120 can ask if the advertiser is willing to pay more to reach a user currently searching on the user system 140. The communication with the content distributor can take place over various mediums, for example, via an email or a telephone call. The communication can also take place as part of an automated system, for example by interfacing with an online reservation system, and activating the control 160 automatically.

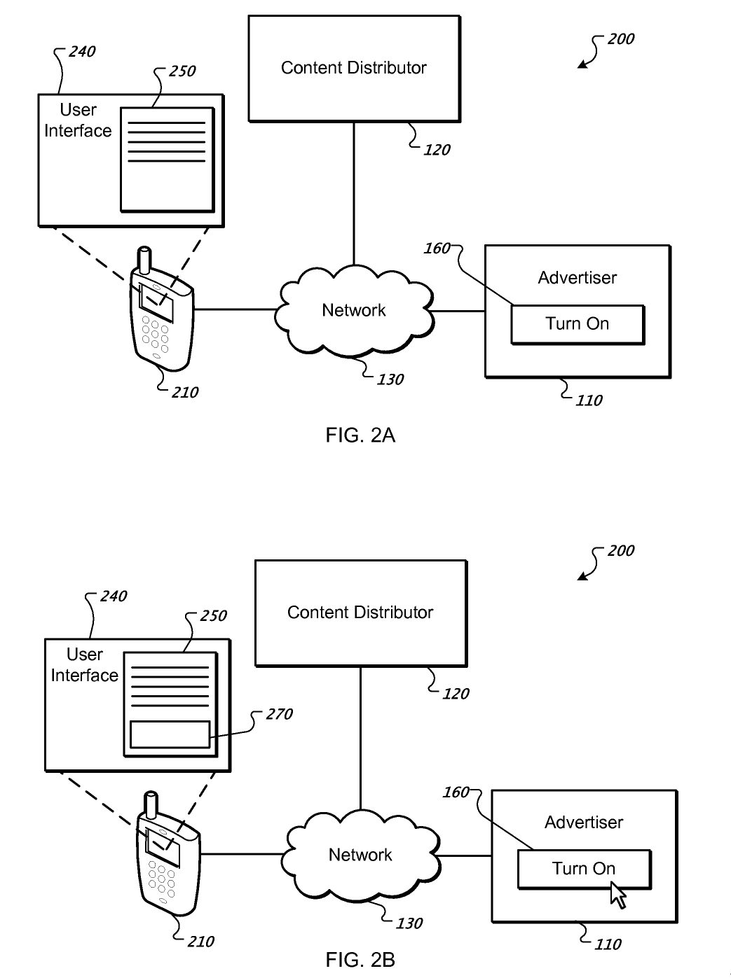

FIG. 2A and FIG. 2B depict an example system 200 that can provide just-in-time content distribution over a voice medium. For example, a user may use a telephone 210 or another voice communication medium such as a cellular phone or Voice Over IP (VOIP) service to connect with the system 200, and access a user interface 240 to receive content 250. For example, a user can search for a business or a business type in a particular geographic location. Input from the user can be determined by voice recognition, or touch tones generated from the user pressing a button, to name two examples. In some implementations, the system 200 provides a call-in directory service, where users can dial a specified number and request information about businesses, for example.

The operator of the advertiser system 110 may wish to advertise a service or product to users of the system 200 in a timely matter. The advertiser may also have intermittent periods of activity and therefore has the capacity to take on new customers. For example, a cab driver wants to advertise immediately that he or she has an opening. The cab driver may be in a particular location and wishes to advertise to potential customers searching for transportation in the particular location. In that example, since the cab driver is in different locations and different times, the cab driver may wish to turn on and off the advertisement 270 in real time, or switch the advertisement content based on the location of the cab at a given time or the estimated time of arrival at a particular location. The cab driver may also be willing to bid more for an immediate advertisement to those potential customers, or a higher ranking of the advertisement 270 as compared to other advertisements (e.g., placing the advertisement at a more noticeable location among the search results).

In FIG. 2B, the operator of the advertiser system 110 activates a control to turn on the advertisement 270. The content the advertiser provides is sent to or identified for the content distributor 120, who then can provide content over the network 130 to users. The content provided to users can include an advertisement 270, for example, as either as part of a list of search results, or in addition to the search results. In some implementations, the advertisement 270 can be a spoken message identifying an advertiser. For example, a user who contacts a call-in directory service asking about taxi services can be given the contact information for a cab driver in the vicinity who has announced his or her ability to take on a fare.

In some implementations, the advertisement 270 can be provided to the user according to a presentation plan, and the recipient can be chosen according the business type the user is searching for. For example, if a user was searching for cab companies in a particular location, the advertisement 270 can be provided with an option for the user to connect to the cab company immediately. The connection can be in the form of a telephone call, or a data connection, to name two examples. Alternatively, the user can hang up from the system and dial the number of the business directly. The user can instead ignore the advertisement and/or listen to the next search result. The user can contact an advertiser with some alternative method, for example, visiting the advertiser's website.

Upon a successful booking, the operator of the advertiser system 110 can turn off the advertisement or can leave it on, for example, if there are multiple cabs available. In some implementations, the advertiser's presentation plan specifies how long the advertisement should remain in effect after activation, such as until a qualifying customer response is received. The content distributor can track various metrics relating to the user actions, and can bill the advertiser appropriately. As with the system 100, in some implementations the content distributor 120 can contact the advertiser system 110 in real time to determine if the advertiser wishes to advertise to a user. For example, if a large number of people were leaving a concert or sporting event and looking for transportation, the content distributor 120 can contact advertisers to determine if they wish to be part of the bidding process.

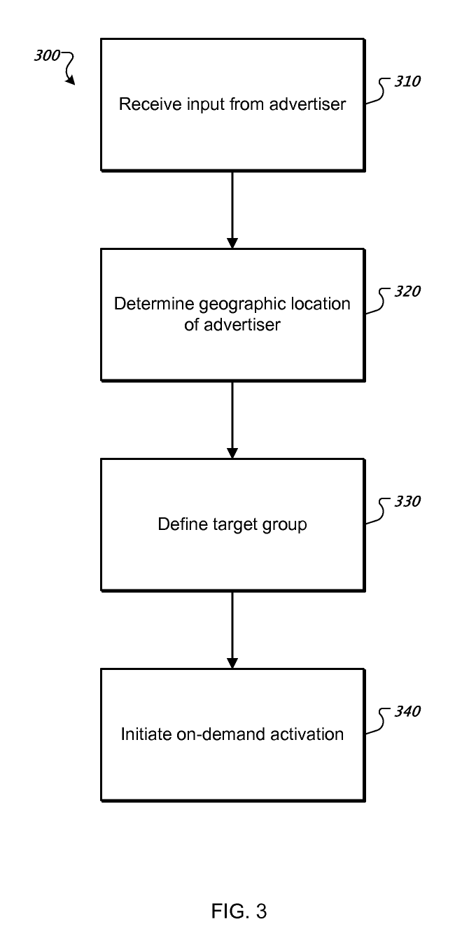

FIG. 3 is a flowchart depicting an example process 300 for just-in-time content distribution. The process 300 can be performed by a processor executing instructions from a computer-readable medium, such as in the system 100. More or fewer steps can be performed; as another example, one or more of the steps can be performed in a different order.

In step 310, an input from an advertiser is received in a computer system. For example, the input can be generated in the content distributor system 120 from the advertiser system 110 (FIG. 1). The advertiser has previously registered an advertisement for on-demand activation. For example, an advertiser such as a plumber can register the advertisement 170 for display when the plumber currently has an open slot in his or her schedule. The input is generated based on the advertiser having an immediate availability and directs the computer system to initiate the on-demand activation substantially in real time with receiving the input. For example, the advertiser can click on, or otherwise activate, the control 160 (FIG. 1).

In step 320, a geographic location of the advertiser is determined using the computer system. The geographic location corresponds to the immediate availability. For example, the advertiser system 110 can be a mobile device that notifies the content distributor system 120 of its location, for example at regular or random times, or in connection with generating the input. As another example, the content distributor system 120 can inquire about the advertiser system's location, at regular or random times, or in response to receiving the input. As another example, the advertiser can input a location where the advertiser expects to be in the near future when the immediate availability occurs, such as in a city that the advertiser is approaching by vehicle; in a particular building that the advertiser is entering, or on a particular floor of a multi-story building, to name just a few examples.

In step 320, a target group to which the advertisement is to be presented is defined using the computer system. The target group is identified based on at least the geographic location and the immediate availability. In some implementations, the target group can be defined such that it contains a significant number of recipients who are expected to need the advertiser's availability at or near the advertiser's location. For example, when the advertisement is for plumbing services the target group can be defined so that it includes any computer user at the advertiser's current location (e.g., city, town, borough, district, neighborhood, block, etc.) who initiates an online query using one or more keywords related to plumbing.

In step 340, the on-demand activation is initiated using the computer system, for receipt of the advertisement by at least part of the target group. The on-demand activation is initiated substantially in real time with receiving the input. For example, the content distributor system 120 can make the advertisement 170 available for presentation substantially as soon as the system receives the advertiser's input. In some implementations, the on-demand activation directly causes the advertisement to be displayed, and in some implementations, the on-demand activation makes the advertisement subject to presentation, for example upon a particular page being requested or a particular search query being run.

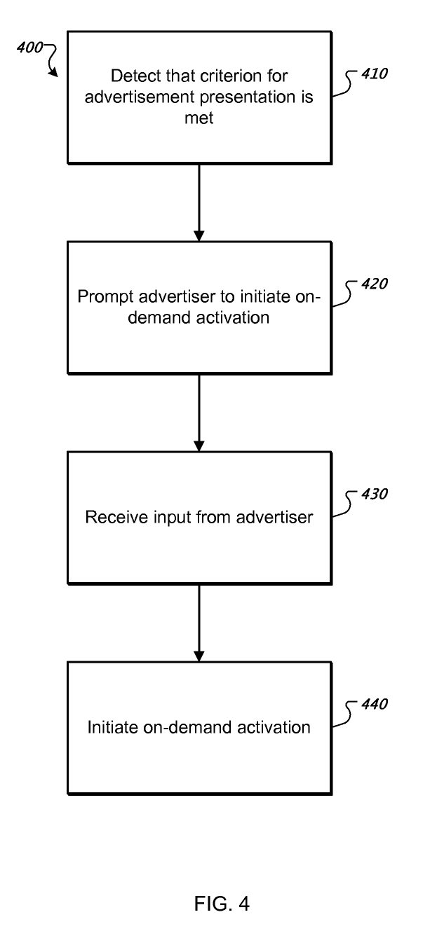

FIG. 4 is a flowchart depicting an example process 400 for just-in-time content distribution. The process 400 can be performed by a processor executing instructions from a computer-readable medium, such as in the system 100. More or fewer steps can be performed; as another example, one or more of the steps can be performed in a different order.

In step 410, a detection is made in a computer system that a criterion for advertisement presentation on behalf of at least one advertiser is met. The advertiser has previously registered an advertisement as subject to on-demand activation. For example, a system that provides call-in directory service (see, e.g., FIGS. 2A-B) can detect that a calling user is requesting information on a particular service, such as tree removal. This request can satisfy the criterion for advertisement presentation regarding one or more tree removal contractors who have previously registered their advertisements for on-demand activation.

In step 420, the advertiser is prompted, substantially in real time with the detection, to initiate the on-demand activation. The prompting is performed using the computer system. For example, the system in FIGS. 2A-B can contact the advertiser system 110 (such as by an electronic message or other alert) and ask the advertiser whether the advertisement should be turned on.

In step 430, an input from the advertiser is received in the computer system. The input directs the computer system to initiate the on-demand activation substantially in real time with receiving the input. For example, the advertiser system 110 can respond to the content distributor system 120 using the same or a different communication channel than the one by which it was prompted.

In step 440, the on-demand activation is initiated using the computer system for receipt of the advertisement by at least part of a target group. The on-demand activation is initiated substantially in real time with receiving the input. For example, the call-in directory can begin presenting one or more advertisements for tree removal contractors to the user who has requested directory information.

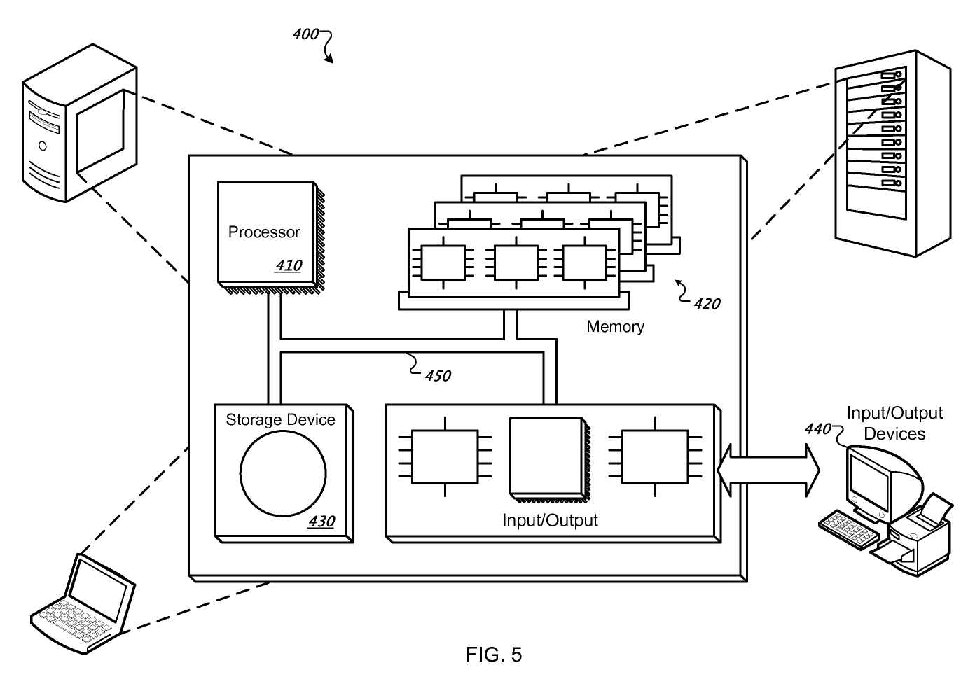

FIG. 5 is a schematic diagram of a generic computer system 500. The system 500 can be used for the operations described in association with any of the computer-implement methods described previously, according to one implementation. The system 500 includes a processor 510, a memory 520, a storage device 530, and an input/output device 540. Each of the components 510, 520, 530, and 540 are interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device.

The input/output device 540 provides input/output operations for the system 500. In one implementation, the input/output device 540 includes a keyboard and/or pointing device. In another implementation, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of this disclosure. Accordingly, other embodiments are within the scope of the following claims.

What is claimed is:

1. A computer-implemented method for advertisement distribution, the method comprising:
receiving, in a computer system, an input from an advertiser that has previously registered an advertisement for on-demand activation, the input being generated based on the advertiser having an immediate availability and directing the computer system to initiate the on-demand activation substantially in real time with receiving the input;
determining, using the computer system, a geographic location of the advertiser that corresponds to the immediate availability;
defining, using the computer system, a target group to which the advertisement is to be presented, the target group identified based on at least the geographic location and the immediate availability; and
initiating the on-demand activation using the computer system, for receipt of the advertisement by at least part of the target group, the on-demand activation initiated substantially in real time with receiving the input.

2. The computer-implemented method of claim 1, wherein the on-demand activation causes the advertisement to begin being subject to display in an electronic medium.

3. The computer-implemented method of claim 2, wherein the on-demand activation comprises that the advertisement is to be displayed on a page in the electronic medium subject to a determination that the advertisement relates to the page.

4. The computer-implemented method of claim 1, wherein the on-demand activation causes the advertisement to begin being subject to performance in a voice communication medium.

5. The computer-implemented method of claim 4, wherein the voice communication medium is configured for prospective customers to seek information about a business type, and wherein the on-demand activation comprises that the advertisement is to be communicated in the voice communication medium to at least one of the prospective customers subject to a determination that the advertiser is associated with the business type.

6. The computer-implemented method of claim 1, further comprising:
determining a business type of the advertiser before identifying the target group;
wherein the target group is identified based also on the business type.

7. The computer-implemented method of claim 6, wherein the business type is one where prospective customers of the business type have an essentially immediate need for a business of the business type.

8. The computer-implemented method of claim 6, wherein the business type is one where the advertiser has intermittent periods of inactivity during which the advertiser has capacity to take on a new customer.

9. The computer-implemented method of claim 1, wherein the advertiser had previously bid a first amount for presentation of the advertisement, and wherein the input corresponds to the advertiser increasing the first amount to a second amount.

10. The computer-implemented method of claim 9, wherein the on-demand activation defines an end time where the on-demand activation is to terminate.

11. The computer-implemented method of claim 10, wherein the end time is defined such that the on-demand activation is to be terminated upon receipt of a response from at least one member of the target group.

12. The computer-implemented method of claim 11, further comprising:
detecting the response from the member to the advertisement; and
recording information about the response in association with at least one of the advertiser or the advertisement.

13. The computer-implemented method of claim 12, wherein the advertisement is presented in a first medium and the response from the member occurs in a second medium other than the first medium.

14. The computer-implemented method of claim 12, further comprising:
forwarding a communication to the advertiser indicating that the response was received as a result of the on-demand activation.

15. A computer-implemented method for advertisement distribution, the method comprising:
detecting, in a computer system, that a criterion is met for advertisement presentation on behalf of at least one advertiser, wherein the advertiser has previously registered an advertisement as subject to on-demand activation;
prompting the advertiser, using the computer system and substantially in real time with the detection, to initiate the on-demand activation;
receiving an input from the advertiser in the computer system, the input directing the computer system to initiate the on-demand activation substantially in real time with receiving the input; and
initiating the on-demand activation using the computer system, for receipt of the advertisement by at least part of a target group, the on-demand activation initiated substantially in real time with receiving the input.

16. The computer-implemented method of claim 15, wherein the advertiser had previously bid a first amount for presentation of the advertisement, and wherein the input corresponds to the advertiser increasing the first amount to a second amount.

17. The computer-implemented method of claim 16, wherein the on-demand activation defines an end time where the on-demand activation is to terminate.

18. The computer-implemented method of claim 17, wherein the end time is defined such that the on-demand activation is to be terminated upon receipt of a response from at least one member of the target group.

19. The computer-implemented method of claim 18, further comprising:
detecting the response from the member to the advertisement; and
recording information about the response in association with at least one of the advertiser or the advertisement.
